(19) United States
(12) Patent Application Publication
(10) Pub. No.: US 2026/0014473 A1
(43) Pub. Date: Jan. 15, 2026

(54) Virtual Object Control Method and Apparatus, Storage Medium, and Electronic Device

(71) Applicant: Tencent Technology (Shenzhen) Company Limited, Shenzhen (CN)

(72) Inventor: Jiakun Shao, Shenzhen (CN)

(21) Appl. No.: 19/336,797

(22) Filed: Sep. 23, 2025

Related U.S. Application Data
(63) Continuation of application No. 19/089,715, filed on Mar. 25, 2025.
Application No. 19/089,715 is a continuation of application No. PCT/CN2024/071487, filed on Jan. 10, 2024.

(30) Foreign Application Priority Data
Mar. 31, 2023 (CN) 2023103796568

(51) Int. Cl. A63F 13/58

(52) U.S. Cl. CPC A63F 13/58

(57) ABSTRACT

A method comprises: displaying a target virtual object and an auxiliary virtual object associated with the target virtual object in a current virtual scene; displaying the auxiliary virtual object performing a target auxiliary action in the current virtual scene; determining, based on the target auxiliary action, a target auxiliary area; and setting the target virtual object located in the target auxiliary area to a protected state.

### RELATED APPLICATIONS

This application is a continuation application of U.S. application Ser. No. 19/089,715, filed Mar. 25, 2025, which is a continuation of PCT Application No. PCT/CN2024/071487, filed on Jan. 10, 2024, which claims priority to Chinese Patent Application No. 202310379656.8, filed on Mar. 31, 2023, each entitled “VIRTUAL OBJECT CONTROL METHOD AND APPARATUS, STORAGE MEDIUM, PROGRAM PRODUCT, AND ELECTRONIC DEVICE,” and each of which is incorporated herein by reference in its entirety.

### FIELD

The present disclosure relates to the field of computers, and specifically, to a virtual object control method and apparatus, a storage medium, a program product, and an electronic device.

### BACKGROUND

Currently, in a game application, when a virtual object controlled by a current player is injured to the ground, rescue may usually be provided by a virtual object controlled by a teammate player. For example, a virtual life value may be restored through a rescue operation for the virtual object controlled by the current player, to continue a game battle.

However, in a process in which the teammate player rescues the current player, the teammate player is easily attacked by an enemy player to cause a rescue failure, or even the teammate player and the current player are attacked at the same time to exit the game. Therefore, in an existing game control method, when a virtual object controlled by a player is attacked, there is a technical problem that an effective protection method cannot be provided for the virtual object.

For the foregoing problem, no effective solution has been provided yet.

### SUMMARY

Embodiments of the present disclosure provide a virtual object control method and apparatus, a storage medium, a program product, and an electronic device, to solve at least a technical problem that there are few protection methods provided for a virtual object in an existing game process.

According to an aspect of an embodiment of the present disclosure, a virtual object control method is provided. The method is performed by an electronic device and includes:
displaying a target virtual object and an auxiliary virtual object associated with the target virtual object in a current virtual scene;
displaying the auxiliary virtual object performing a target auxiliary action in the current virtual scene;
determining, based on the target auxiliary action, a target auxiliary area; and
setting the target virtual object located in the target auxiliary area to a protected state.

According to another aspect of an embodiment of the present disclosure, a virtual object control apparatus is further provided. The apparatus includes:
a display unit, configured to display a target virtual object and an auxiliary virtual object associated with the target virtual object in a current virtual scene, and display the auxiliary virtual object performing a target auxiliary action in the current virtual scene.
a control unit, configured to determining, based on the target auxiliary action, a target auxiliary area; and
an adjustment unit, configured to set the target virtual object located in the target auxiliary area to a protected state.

According to another aspect of an embodiment of the present disclosure, a computer-readable storage medium is further provided. The computer-readable storage medium has a computer program stored therein. The computer program is configured for performing, when executed, the foregoing virtual object control method.

According to another aspect of an embodiment of the present disclosure, a computer program product is provided. The computer program product includes a computer program/instruction. The computer program/instruction is stored in a computer-readable storage medium. A processor of a computer device reads the computer program/instruction from the computer-readable storage medium. The processor executes the computer program/instruction, to cause the computer device to perform the foregoing virtual object control method.

According to another aspect of an embodiment of the present disclosure, an electronic device is further provided, including a memory and a processor. The memory has a computer program stored therein. The processor is configured to perform the foregoing virtual object control method through the computer program.

### BRIEF DESCRIPTION OF THE DRAWINGS

The accompanying drawings described herein are used to provide a further understanding of the present disclosure, and form part of the present disclosure. Exemplary embodiments of the present disclosure and descriptions thereof are used to explain the present disclosure, and do not constitute any limitation to the present disclosure. In the accompanying drawings:

FIG. 1 is a schematic diagram of a hardware environment of an exemplary virtual object control method according to an embodiment of the present disclosure.

FIG. 2 is a flowchart of an exemplary virtual object control method according to an embodiment of the present disclosure.

FIG. 3 is a schematic diagram of an exemplary virtual object control method according to an embodiment of the present disclosure.

FIG. 4 is a schematic diagram of another exemplary virtual object control method according to an embodiment of the present disclosure.

FIG. 5 is a schematic diagram of still another exemplary virtual object control method according to an embodiment of the present disclosure.

FIG. 6 is a schematic diagram of still another exemplary virtual object control method according to an embodiment of the present disclosure.

FIG. 7 is a schematic diagram of still another exemplary virtual object control method according to an embodiment of the present disclosure.

FIG. 8 is a schematic diagram of still another exemplary virtual object control method according to an embodiment of the present disclosure.

FIG. 9 is a schematic diagram of still another exemplary virtual object control method according to an embodiment of the present disclosure.

FIG. 10 is a schematic diagram of still another exemplary virtual object control method according to an embodiment of the present disclosure.

FIG. 11 is a flowchart of another exemplary virtual object control method according to an embodiment of the present disclosure.

FIG. 12 is a schematic diagram of still another exemplary virtual object control method according to an embodiment of the present disclosure.

FIG. 13 is a schematic diagram of still another exemplary virtual object control method according to an embodiment of the present disclosure.

FIG. 14 is a schematic diagram of still another exemplary virtual object control method according to an embodiment of the present disclosure.

FIG. 15 is a flowchart of another exemplary virtual object control method according to an embodiment of the present disclosure.

FIG. 16 is a schematic structural diagram of an exemplary virtual object control apparatus according to an embodiment of the present disclosure.

FIG. 17 is a schematic structural diagram of an exemplary electronic device according to an embodiment of the present disclosure.

### DESCRIPTION OF EMBODIMENTS

In order for those skilled in the art to better understand the solutions of the present disclosure, the following describes the solutions in the embodiments of the present disclosure with reference to the accompanying drawings in the embodiments of the present disclosure. The described embodiments are only some of the embodiments of the present disclosure rather than all of the embodiments. All other embodiments obtained by those of ordinary skill in the art based on the embodiments of the present disclosure without creative efforts shall fall within the protection scope of the present disclosure.

In the specification, claims, and accompanying drawings of the present disclosure, the terms “first”, “second”, and the like are configured for distinguishing similar objects but not necessarily indicating a specific order or sequence. Such used data is interchangeable where appropriate so that the embodiments of the present disclosure described here can be implemented in an order other than those illustrated or described here. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

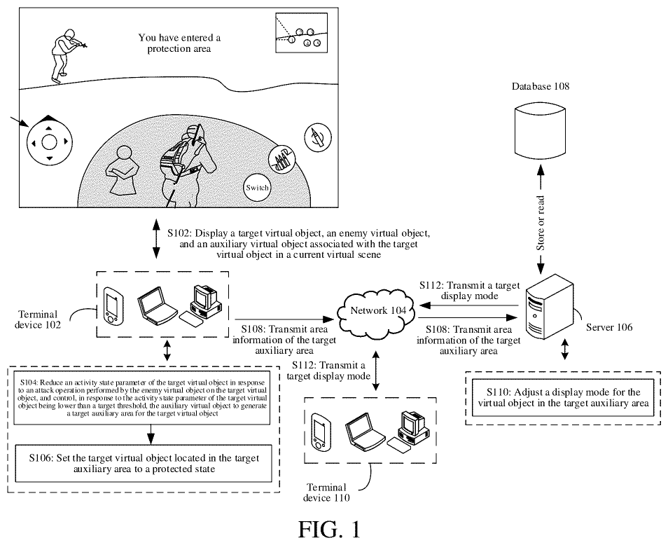

According to one aspect of an embodiment of the present disclosure, a virtual object control method is provided. As an exemplary implementation, the foregoing virtual object control method may be applied to, but is not limited to, a virtual object control system in a hardware environment shown in FIG. 1. The virtual object control system may include, but is not limited to, a terminal device 102, a network 104, a server 106, a database 108, and a terminal device 110. A target client runs in the terminal device 102 and the terminal device 110 separately (as shown in FIG. 1, an example in which the target client is a game application client is used). The terminal device 102 and the terminal device 110 separately include a human-computer interaction screen, a processor, and a memory. The human-computer interaction screen is configured to display a virtual game scene (the virtual game scene shown in FIG. 1), and is further configured to provide a human-computer interaction interface to receive a human-computer interaction operation for controlling a virtual object controlled in a virtual scene, where the virtual object completes a game task set in the virtual scene. The processor is configured to generate an interaction instruction in response to the human-computer interaction operation, and transmit the interaction instruction to the server. The memory is configured to store related attribute data, such as object attribute information of the controlled virtual object and attribute information of a held virtual prop. The attribute information herein may include, but is not limited to, information for identifying an identity and a current position of the virtual prop.

A client that controls a target virtual object runs in the terminal device 102. In some embodiments, in a case that the enemy virtual object is a virtual object controlled by the terminal device, a client that controls the enemy virtual object runs in the terminal device 110. The target virtual object and the enemy virtual object herein may be controlled to perform a particular interaction event in a game, for example, an attack event, a defense event, or a skill cast event.

Furthermore, the server 106 includes a processing engine. The processing engine is configured to perform a storing or reading operation on the database 108. Specifically, the processing engine reads, from the database 108, virtual scene information of each virtual object and operation information executed by the virtual object. It is assumed that the terminal device 102 in FIG. 1 is configured to control a target virtual object and reference virtual objects (including a friend virtual object and an enemy virtual object) in a same game task. A process of this embodiment includes the following operations.

Operation S102: Display a target virtual object, an enemy virtual object, and an auxiliary virtual object associated with the target virtual object in a current virtual scene, where the enemy virtual object and the target virtual object are located in different camps separately.

Operation S104: Reduce an activity state parameter of the target virtual object in response to an attack operation performed by the enemy virtual object on the target virtual object, and control, in response to the activity state parameter of the target virtual object being lower than a target threshold, the auxiliary virtual object to generate a target auxiliary area for the target virtual object.

Operation S106: Set the target virtual object located in the target auxiliary area to a protected state, where a first hit ratio of the attack operation launched by the enemy virtual object on the target virtual object in the protected state is lower than a second hit ratio of the attack operation launched by the enemy virtual object on the target virtual object not in the protected state.

Next, in operation S108, the terminal device 102 transmits area information of the target auxiliary area to the server 106 through the network 104.

Then, the server 106 performs operation S110 to adjust a display mode for the virtual object in the target auxiliary area.

Next, in operation S112, the server 106 transmits a target display mode to the terminal device 110 through the network 104.

Finally, the target virtual object is displayed in the terminal device 110 in the target display mode.

In some embodiments, in a case that the game client running in the terminal device 110 is configured to control a friend virtual object in a same camp with the target virtual object, the target display mode is the same as a display mode of displaying the target virtual object in the terminal device 102. In a case that the game client running in the terminal device 110 is configured to control an enemy virtual object in an opposing camp with the target virtual object, the target display mode is different from the display mode of displaying the target virtual object in the terminal device 102. For example, an invisible display mode may be used for the enemy virtual object.

In another exemplary implementation, when the terminal device 102 or the terminal device 110 has a relatively strong computing processing capability, the foregoing operation S110 may alternatively be completed by the terminal device 102 or the terminal device 110. This description is merely an example. This is not limited in any way in this embodiment.

In this embodiment, the foregoing terminal device may be a terminal device configured with a target client, and may include, but is not limited to, at least one of the following: a mobile phone (such as an Android mobile phone or an iOS mobile phone), a notebook computer, a tablet computer, a palmtop computer, a mobile Internet device (MID), a PAD, a desktop computer, a smart television, or the like. The target client may be a client that supports providing a shooting game task, such as a video client, an instant messaging client, a browser client, or an education client. The foregoing network may include, but is not limited to, a wired network and a wireless network. The wired network includes: a local area network, a metropolitan area network, and a wide area network. The wireless network includes: Bluetooth, wireless fidelity (WIFI), and another network for wireless communication. The foregoing server may be one server, a server cluster formed by a plurality of servers, or a cloud server. The foregoing description is merely an example. This is not limited in any way in this embodiment.

In this embodiment, the foregoing virtual object control method may be applied to, but is not limited to, a gaming terminal application (APP) that completes a given adversarial game task in a virtual scene, for example, a virtual adversarial game application in a multiplayer online battle arena (MOBA) application. The adversarial game task may be, but is not limited to, a game task completed by a current player through adversarial interaction between a virtual object in a virtual scene controlled by a human-computer interaction virtual object and a virtual object controlled by another player.

The foregoing virtual object control method may further be applied to a terminal application of a multiplayer online role-playing game (MMORPG) type. In this type of game, a current player may complete a social game task in the game in a role-playing mode and at a first perspective of a virtual object, for example, complete a game task together with another virtual object. The social game task herein may be but is not limited to running in an application (for example, a game APP not running independently) in a form of a plug-in or a mini program, or running in an application (for example, a game APP running independently) in a game engine. The type of the foregoing game application may include, but is not limited to, at least one of the following: a two-dimensional (2D) game application, a three-dimensional (3D) game application, a virtual reality (VR) game application, an augmented reality (AR) game application, or a mixed reality (MR) game application. The foregoing description is merely an example. This is not limited in any way in this embodiment.

The foregoing implementation of the present disclosure may further be, but is not limited to, applied to a game of an open world type. The so-called open world refers to that a combat scene in the game is completely free and open, a player may freely move forward to explore in any direction, and a distance between boundaries of various orientations is very large. In addition, there are simulation objects of various shapes and sizes in the scene, which can generate various physical collisions or interactions with entities such as a player and AI. In the open world game, the player may control a game task completed by a virtual object through adversarial interaction.

In this embodiment of the present disclosure, a target virtual object, an enemy virtual object, and an auxiliary virtual object managed by the target virtual object are displayed in a current virtual scene, where the enemy virtual object and the target virtual object are located in different camps separately. In response to an attack operation performed by the enemy virtual object on the target virtual object, an activity state parameter of the target virtual object is reduced. In response to the activity state parameter of the target virtual object being lower than a target threshold, the first auxiliary virtual object is controlled to generate a target auxiliary area for the target virtual object. The target virtual object located in the target auxiliary area is set to a protected state, where a first hit ratio of the attack operation launched by the enemy virtual object on the target virtual object in the protected state is lower than a second hit ratio of the attack operation launched by the enemy virtual object on the target virtual object not in the protected state, thereby providing an effective protection method for a virtual object of a player.

In the foregoing implementation, an auxiliary virtual object is configured for a target virtual object, an auxiliary area for providing protection is automatically generated for the target virtual object through the auxiliary virtual object in a case that an activity state parameter of the target virtual object is less than a target threshold, and similar to a case that the target virtual object is located in the auxiliary area, the auxiliary area provides protection for the target virtual object, so as to avoid or resist an attack by an enemy virtual object in a case that the target virtual object is frail or has relatively high operating difficulty, thereby prolonging a living time of the target virtual object in a game battle, and solving a technical problem that relatively few protection methods are provided for a virtual object in an existing game process.

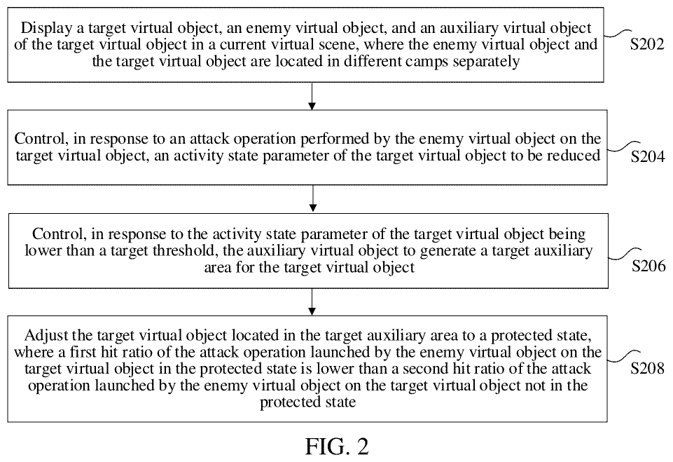

As an exemplary implementation, FIG. 2 is a flowchart of an exemplary virtual object control method according to an embodiment of the present disclosure. The foregoing virtual object control method is performed by an electronic device. For example, the method is performed by the server 106 and the terminal device 110 in FIG. 1 together, or is performed by the terminal device 110. As shown in FIG. 2, the method includes the following operations.

S202: Display a target virtual object, a second virtual object, and a first auxiliary virtual object associated with the target virtual object in a current virtual scene, where the second virtual object and the target virtual object are located in different camps separately.

In this embodiment of the present disclosure, the second virtual object is also referred to as an enemy virtual object. An auxiliary virtual object associated with the target virtual object is recorded as a first auxiliary virtual object, and an auxiliary virtual object associated with the enemy virtual object is recorded as a second auxiliary virtual object.

S204: Reduce an activity state parameter of the target virtual object in response to an attack operation performed by the second virtual object on the target virtual object.

S206: Control, in response to the activity state parameter of the target virtual object being lower than a target threshold, the first auxiliary virtual object to generate a target auxiliary area for the target virtual object.

S208: Set the target virtual object located in the target auxiliary area to a protected state, where a first hit ratio of the attack operation launched by the second virtual object on the target virtual object in the protected state is lower than a second hit ratio of the attack operation launched by the second virtual object on the target virtual object not in the protected state.

In this implementation, the first auxiliary virtual object configured for the target virtual object may be a virtual object providing an auxiliary protection skill for the target virtual object. In an exemplary mode, in a game battle, a plurality of types of auxiliary skills may be provided for the first auxiliary virtual object configured for the target virtual object, including, but not limited to, an auxiliary protection skill, an auxiliary attack skill, an auxiliary monitoring skill, an auxiliary resource collection skill, and the like.

In this implementation, the first auxiliary virtual object may be configured with an auxiliary protection skill, to protect the target virtual object by generating a target auxiliary area for the target virtual object through the first auxiliary virtual object in a case that the activity state parameter of the target virtual object is lower than the target threshold.

In some embodiments, in a case that the first auxiliary virtual object is further configured with an auxiliary attack skill, the first auxiliary virtual object may be configured for automatically attacking a virtual object in an adversarial camp. In a case that the first auxiliary virtual object is further configured with an auxiliary monitoring skill, the first auxiliary virtual object may be configured for automatically monitoring a nearby virtual environment for the target virtual object, for example, automatically monitoring and finding an enemy virtual object in a hidden adversarial camp in a nearby environment. In a case that the first auxiliary virtual object is further configured with an auxiliary resource collection skill, the first auxiliary virtual object may be configured for automatically collecting virtual resources in a game scene for the target virtual object, including but not limited to resources such as virtual material supplies, virtual gold coins, and virtual props.

The auxiliary protection skill may be further embodied as that the first auxiliary virtual object is configured for: taking, for the target virtual object, an attack damage caused by the enemy virtual object. For example, in a case that the target virtual object is attacked by the enemy virtual object, the first auxiliary virtual object may be automatically moved to the front of the target virtual object, to resist the attack damage. A virtual protection skill may further be embodied in a gain effect such as restoring a virtual life value for the target virtual object or improving a virtual armor value for the target virtual object.

In this implementation, the auxiliary skills that may be provided by the first auxiliary virtual object are not limited.

Before operation S202, the first auxiliary virtual object may further be configured for the target virtual object, or the auxiliary skill may be configured for the first auxiliary virtual object through a pre-configuration operation.

For example, the configuration operation may be that before a game battle starts, a player obtains the first auxiliary virtual object having the auxiliary skill through a virtual resource exchange operation, or the player may determine, through a selection operation, a first auxiliary virtual object configured for a current battle from a plurality of candidate auxiliary virtual objects. For another example, the configuration operation may alternatively be that an auxiliary skill of the first auxiliary virtual object is determined through a resource exchange operation when it is determined that the player is configured with the first auxiliary virtual object, for example, the skill of generating the target auxiliary area for the target virtual object, or may be one or more of skills such as the auxiliary protection skill, the auxiliary attack skill, the auxiliary monitoring skill, and the auxiliary resource collection skill.

The configuration operation may alternatively be completed in a game process. For example, when a particular level in a game is passed, a configuration option is provided for the target virtual object, to determine the first auxiliary virtual object that may provide an auxiliary skill for the target virtual object. In this implementation, the foregoing configuration mode is not limited.

In an exemplary mode, the game process may be set to the following process:

First, before a game starts, a player first obtains a virtual microchip through exchange of virtual resources.

In the game process, a virtual object (NPC object) controlled by a computer in a virtual scene may be attacked through a controlled target virtual object.

In a case that the NPC object is defeated, the defeated NPC object may be “acclimated” to a first auxiliary virtual object subordinate to the target virtual object, and the first auxiliary virtual object may be configured with an auxiliary skill corresponding to the virtual microchip.

For example, when a skill corresponding to the virtual microchip obtained by the player is “Create a protection area” and when the player controls the target virtual object to defeat the NPC virtual object, the defeated NPC virtual object may be converted into the first auxiliary virtual object subordinate to the target virtual object, and the first auxiliary virtual object is configured with the auxiliary skill “Create a protection area” corresponding to the virtual microchip. Further, in a case that a skill cast condition is satisfied, the first auxiliary virtual object may automatically cast the skill of “Create a protection area” for the target virtual object.

Further, a form of the first auxiliary virtual object may be a form of a virtual pet, a form of a virtual character, or a form of a virtual MechWarrior. A specific form type of the first auxiliary virtual object is not limited in this implementation.

In operation S204 and operation S206, the activity state parameter of the target virtual object may include, but is not limited to, a parameter for indicating an operation state of the target virtual object in the game battle. For example, the activity state parameter may include, but is not limited to, a living state parameter for indicating an adversarial activity state of the target virtual object, for example, a virtual life value. The activity state parameter may alternatively be an attack state parameter indicating a damage value of a virtual damage allowed to be caused to the enemy virtual object by the target virtual object, for example, a virtual attack force. The activity state parameter may alternatively be a state parameter indicating a moving speed of the target virtual object in the virtual scene, for example, a virtual moving speed. The activity state parameter may alternatively be an armor state parameter for indicating a defense value allowing the target virtual object to defend against the virtual damage caused by the enemy virtual object, for example, a virtual armor, and the like. In this implementation, specific types of the activity state parameters are not limited.

Corresponding to different types of activity state parameters, in a case that the activity state parameters of the target virtual object are less than the target threshold, virtual activity states of the target virtual object are different. For example, in a case that the activity state parameter is a virtual life value, the activity state parameter of the target virtual object being less than the target threshold may be configured for indicating that the target virtual object is in a state in which the virtual life value is relatively low and the target virtual object is to be eliminated from the game. For another example, in a case that the activity state parameter is a virtual attack force, the activity state parameter of the target virtual object being less than the target threshold may be configured for indicating that the target virtual object is in an impact of a debuff that reduces the virtual attack force. For another example, in a case that the activity state parameter is a virtual moving speed, the activity state parameter of the target virtual object being less than the target threshold may be configured for indicating that the target virtual object is in an impact of a debuff of reducing the moving speed. For another example, in a case that the activity state parameter is a virtual armor, the activity state parameter of the target virtual object being less than the target threshold may be configured for indicating that the target virtual object is in an impact of a debuff of reducing the virtual armor. In this implementation, a specific state meaning corresponding to that the activity state parameter of the target virtual object is less than the target threshold is not limited.

In operation S204, the attack operation performed by the enemy virtual object on the target virtual object may include, but is not limited to, an ordinary attack operation and a skill attack operation.

In a case that the attack operation is an ordinary attack operation, the activity state parameter may correspond to the virtual life value. In a case that the attack operation is the skill attack operation, the activity state parameter may alternatively be a moving speed parameter, an armor parameter, an attacking force parameter, or the like of the virtual object.

For example, in a case that the skill attack operation is a skill for reducing a moving speed, the moving speed of the target virtual object is controlled to be reduced subject to the skill for reducing the moving speed. In a case that the skill attack operation is an attack operation that may cause the virtual object to be vertiginous, the moving speed of the target virtual object is controlled to be reduced to 0 (to be specific, the target virtual object cannot move) subject to the vertigo skill. The attack operation and the corresponding debuff are merely exemplary descriptions, and are not intended to limit specific operation types in this implementation.

Further, in a case that the activity state parameter of the target virtual object is less than the target threshold, it may be determined that the current target virtual object is in a state in which the virtual life value is less than the target threshold or is in an impact of a debuff caused by the enemy virtual object, and then it is determined that the current target virtual object is in a state in which the current target virtual object needs to assist the virtual object in providing a protection skill or a state in which teammate rescue is needed.

In operation S204, the auxiliary virtual object having a follower relationship with the target virtual object may be configured for freely moving in the game virtual scene. In an exemplary mode, the first auxiliary virtual object may be configured for freely moving within a particular distance range from the target virtual object. In another exemplary mode, the foregoing first auxiliary virtual object may alternatively be configured for freely moving at any position in the target game virtual scene.

For the first mode, if it is determined that the target virtual object is in a state in which the auxiliary virtual object needs to provide a protection skill, the auxiliary virtual object may be controlled to generate the target auxiliary area for the target virtual object. In the foregoing second mode, a current distance between the auxiliary virtual object and the target virtual object may be first determined. In a case that a distance condition is satisfied, the auxiliary virtual object is then controlled to generate the foregoing target auxiliary area for the target virtual object.

In an exemplary mode, the target virtual object may further be configured with a plurality of candidate auxiliary virtual objects. In operation S204, when it is determined that the target virtual object is in a state in which the auxiliary virtual object needs to provide a protection skill, the first auxiliary virtual object closest to the target virtual object may be determined, and the target auxiliary area is generated for the target virtual object. In this implementation, the quantity of first auxiliary virtual objects and the distance condition from the target virtual object are not limited.

In operation S204 in this implementation, the first auxiliary virtual object may protect the target virtual object by generating the target auxiliary area for the target virtual object.

The target auxiliary area in operation S204 is further described below. In this implementation, the target auxiliary area may provide a protected state to the target virtual object, so that the target virtual object in the target auxiliary area may be prevented from being damaged by the enemy virtual object or damage to the target virtual object is reduced.

In this implementation, the second virtual object or the enemy virtual object may belong to a game camp different from a game camp in which the current target virtual object is located. For example, the game camp may be an enemy camp formed by virtual objects controlled by enemy players, or may be a neutral camp formed by virtual objects controlled by a computer.

Further, the enemy virtual object may include, but is not limited to, a virtual object controlled by a player and a virtual object controlled by the computer. In a case that the adversarial camp is an enemy camp formed by virtual objects controlled by enemy players, the enemy virtual objects may include the virtual object controlled by the player and the virtual object controlled by the computer. For example, in a case that the virtual object controlled by the enemy player is configured with a corresponding enemy auxiliary virtual object, the virtual object may further include the second auxiliary virtual object, i.e. an enemy auxiliary virtual object. Correspondingly, the target auxiliary area may be configured for resisting a virtual attack or a virtual damage from the enemy auxiliary virtual object.

The following describes a mode in which the target auxiliary area protects the target virtual object in operation S208.

In an exemplary mode, the target auxiliary area may be configured for increasing a dodge probability of the virtual object in the area. To be specific, in a case that the target virtual object is set to a protected state, a dodge parameter of the virtual object in the area is increased, so that a virtual attack from the outside is missing (to be specific, the target virtual object cannot be hit), thereby protecting the virtual object in the target auxiliary area.

In another exemplary mode, the target auxiliary area may be configured for adjusting a display mode of the virtual object in the area, so that the virtual object outside cannot find the target virtual object in the area, thereby preventing the virtual object outside from launching an attack against the target virtual object, and protecting the virtual object in the target auxiliary area. The foregoing function of the target auxiliary area is merely an exemplary description. The specific function of the target auxiliary area is not limited in this implementation.

In an exemplary mode, when the target virtual object is set to the protected state, protection prompt information may be displayed, to indicate that the target virtual object is in the protected state relative to the enemy virtual object. Specifically, a display mode of the foregoing protection prompt information may be displaying a prompt in a text form in a current interface, or may be prompting in a mode of adjusting a display mode of the current interface, or may be prompting in a mode of adjusting a display mode of the target virtual object.

For example, in a case that the prompt is displayed in a text form, the protection prompt information may be “You have entered a protected state”, and is displayed in the center of the current interface, to prompt that the target virtual object is in the protected state.

For another example, in a case that the prompt is displayed by adjusting the display mode of the current interface, the prompt mode may be adjusting a scene color of the current virtual scene. For example, before the target virtual object enters the target auxiliary area, the virtual scene is displayed according to first color saturation. After the target virtual object enters the target auxiliary area, the virtual scene is displayed according to second color saturation, thereby indicating that the target virtual object has entered the target auxiliary area, to prompt that the target virtual object is in the protected state.

For another example, in a case that the prompt is displayed by adjusting the display mode of the target virtual object, the prompt mode may be adjusting the display mode of the target virtual object before the target virtual object enters the target auxiliary scene. For example, before the target virtual object enters the target auxiliary area, the target virtual object is displayed in a first color. After the target virtual object enters the target auxiliary area, the target virtual object is displayed in a second color, thereby indicating that the target virtual object has entered the target auxiliary area, to prompt that the target virtual object is in the protected state.

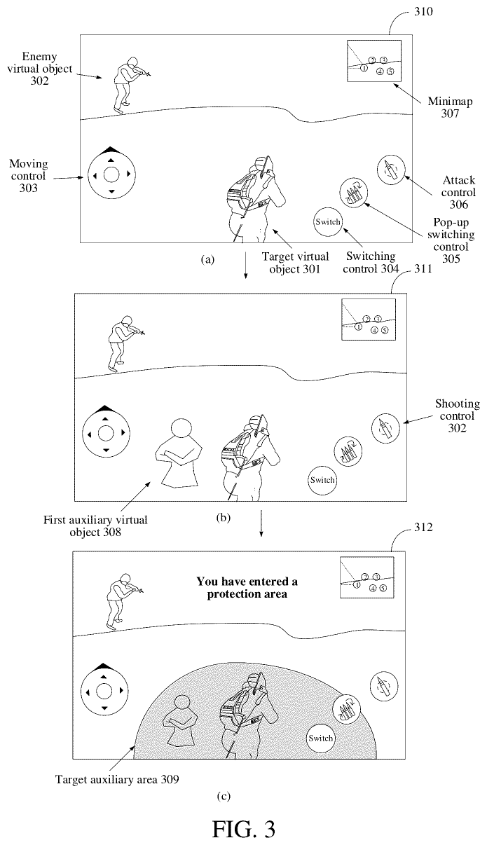

An exemplary implementation of the foregoing implementation is described below with reference to FIG. 3.

As shown in (a) of FIG. 3, a current virtual scene corresponding to a target virtual object 301 is shown in a current game interface 310. The current virtual scene further includes a reference virtual object (i.e., an enemy virtual object) 302 of an enemy camp. The current game interface 310 further shows a moving control 303 for controlling the target virtual object 301 to move, a switching control 304 for controlling the target virtual object 301 to switch a virtual prop, a pop-up switching control 305 for controlling the target virtual object 301 to perform a pop-up switching operation, and an attack control 306 for controlling the target virtual object 301 to launch an attack toward another virtual object. Furthermore, the current game interface 310 further includes a minimap 307 for displaying a scene object and a virtual object in a game scene in a thumbnail mode.

In (a) of FIG. 3, the enemy virtual object 302 may launch an attack to the target virtual object 301 controlled by a player. In a case that the target virtual object 301 is attacked and hurt, a virtual life value of the target virtual object 301 is reduced.

Further, as shown in (b) of FIG. 3, in a game interface 311, in a case that an activity state parameter of a target virtual object is less than a target threshold, for example, in a case that a virtual life value of the target virtual object is less than 10% of a total virtual life value, a first auxiliary virtual object 308 that has been moved to the side of the target virtual object is displayed in a current virtual scene, where the first auxiliary virtual object is configured for providing a protection skill to the target virtual object.

In a case that the first auxiliary virtual object 308 releases the protection skill, as shown in (c) of FIG. 3, a target auxiliary area 309 is next generated on a game interface 312. The target auxiliary area 309 may provide protection to the target virtual object 301 and the first auxiliary virtual object 308 located therein. Meanwhile, protection prompt information “You have entered a protection area” is displayed in the center of the current game interface 312, and the target auxiliary area 309 in which the target virtual object 301 and the first auxiliary virtual object 308 are located is displayed by graying, to prompt that the target virtual object 301 is in a protected state.

The protected state corresponding to the current target auxiliary area may be adjusting the target virtual object to an invisible state, to avoid being found and attacked by an enemy virtual object. In this implementation, even if the enemy virtual object attacks a position of the target auxiliary area 309, the target virtual object cannot be accurately hit since the target virtual object is in the invisible state, thereby protecting the target virtual object.

In this embodiment of the present disclosure, a target virtual object, an enemy virtual object, and a first auxiliary virtual object of the target virtual object are displayed in a current virtual scene, where the enemy virtual object and the target virtual object are located in different camps separately. In response to an attack operation performed by the enemy virtual object on the target virtual object, an activity state parameter of the target virtual object is controlled to be reduced. In response to the activity state parameter of the target virtual object being lower than a target threshold, the first auxiliary virtual object is controlled to generate a target auxiliary area for the target virtual object. The target virtual object located in the target auxiliary area is set to a protected state, where a first hit ratio of the attack operation launched by the enemy virtual object on the target virtual object in the protected state is lower than a second hit ratio of the attack operation launched by the enemy virtual object on the target virtual object not in the protected state, thereby providing an effective protection method for a virtual object of a player.

In the foregoing implementation, a first auxiliary virtual object is configured for a target virtual object, an auxiliary area for providing protection is automatically generated for the target virtual object through the first auxiliary virtual object in a case that an activity state parameter of the target virtual object is less than a target threshold, and in a case that the target virtual object is located in the auxiliary area, the auxiliary area provides protection for the target virtual object, so as to avoid or resist an attack by an enemy virtual object in an adversarial camp in a case that the target virtual object is frail or has relatively high operating difficulty, thereby prolonging a living time of the target virtual object in a game battle, and solving a technical problem that relatively few protection methods are provided for a virtual object in an existing game process.

As an exemplary implementation, the operation of setting the target virtual object located in the target auxiliary area to a protected state includes:
displaying, within the target auxiliary area, the target virtual object in the protected state in a target display mode.

The target display mode indicates that the target virtual object is displayed in a first display mode in an object field of view of a first virtual object (i.e., a friend virtual object), and the target virtual object is displayed in a second display mode in an object field of view of a second virtual object (i.e., an enemy virtual object), where the friend virtual object and the target virtual object are located in a same camp.

In this implementation, the target virtual object located in the target auxiliary area may be protected through a method for adjusting the display mode of the target virtual object in the object field of view of the enemy virtual object.

In an exemplary implementation, the method further includes the following operations.

S1: Display a target virtual object within a target auxiliary area in a first display mode.

S2: Display target protection prompt information for indicating a display mode of the target virtual object, where the target protection prompt information is configured for prompting to display the target virtual object in an object field of view of an enemy virtual object in a second display mode.

In this implementation, the target protection prompt information may be displayed after the display mode of the target virtual object is adjusted, to indicate the second display mode of displaying the target virtual object in the object field of view of the enemy virtual object.

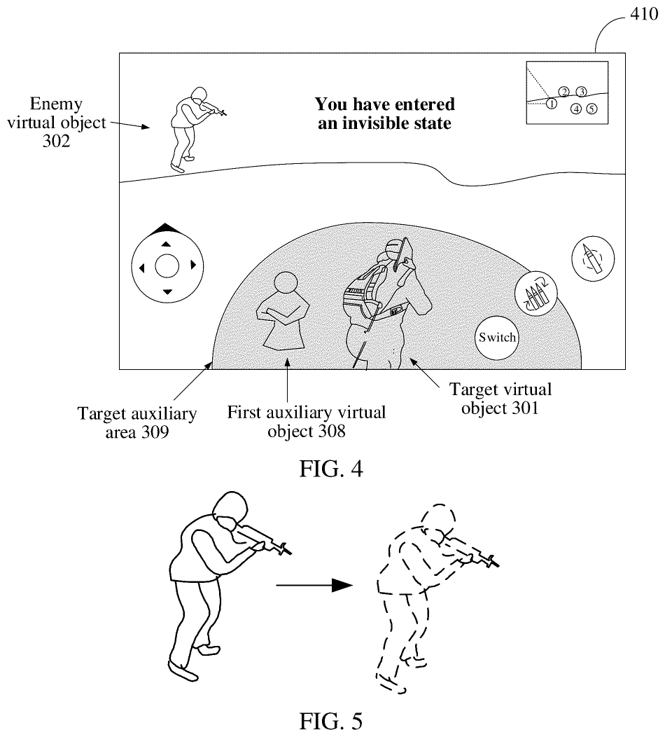

For example, as shown in FIG. 4, after the target virtual object enters the foregoing target auxiliary area, the target virtual object is displayed in a semi-transparent mode (a gray display mode is displayed in the figure), and target protection prompt information “You have entered an invisible state” is displayed on a current game interface 410, to indicate that an invisible display mode is configured for displaying in the object field of view of the enemy virtual object, thereby indicating that a protected state is provided for the target virtual object by adjusting the display mode of the target virtual object.

The foregoing form of displaying the target protection prompt information in FIG. 4 is merely an example, and various other exemplary modes may be configured for displaying. For example, a current game interface may be displayed according to a particular transparency, to prompt the current target virtual object to enter an invisible state. For another example, the target virtual object on the current game interface may be displayed according to a target style, to prompt the current target virtual object to enter the invisible state.

According to the foregoing implementation of the present disclosure, a target virtual object is displayed within a target auxiliary area in a first display mode. Target protection prompt information for indicating a display mode of the target virtual object is displayed, where the target protection prompt information is configured for prompting to display the target virtual object in an object field of view of an enemy virtual object in a second display mode, so as to prompt that the target virtual object can be protected in the target auxiliary area by adjusting the display mode of the target virtual object.

As an exemplary mode, when the target virtual object in the protected state is displayed within the target auxiliary area in a target display mode, the method further includes performing at least one of the following:

1) Adjust a parameter restoration speed of a living state parameter of the target virtual object from a first restoration speed to a second restoration speed, where the living state parameter is configured for indicating an adversarial activity state of the target virtual object, the parameter restoration speed is the first restoration speed when the target virtual object is located outside the target auxiliary area, and the second restoration speed is greater than the first restoration speed.

2) Increase the living state parameter of the target virtual object by a first target value.

3) Increase an attack state parameter of the target virtual object by a second target value, where the attack state parameter is configured for indicating a damage value at which the target virtual object is allowed to cause a virtual damage to the enemy virtual object.

4) Increase an armor state parameter of the target virtual object by a third target value, where the armor state parameter is configured for indicating a defense value at which the target virtual object is allowed to defend against the virtual damage caused by the enemy virtual object.

In this implementation, the target auxiliary area may further provide a plurality of gain effects to the target virtual object to improve a protection effect on the target virtual object. For example, the first gain effect may be improving a restoration speed of the virtual life value of the target virtual object. The second gain effect may be directly improving the virtual life value of the target virtual object. The third gain effect may be improving a virtual attack force of the target virtual object. The fourth gain effect may be improving a virtual armor of the target virtual object.

Furthermore, the target auxiliary area may further provide a virtual dodge effect to the target virtual object. For example, there may be a probability that an attack from the enemy virtual object on the target virtual object may fall. The gain effect of the target auxiliary area is merely an exemplary description. The type and combination of specific gain effects of the target auxiliary area are not limited in this implementation.

According to the foregoing implementation of the present disclosure, a plurality of exemplary gain effects are matched for a target auxiliary area, thereby improving a protection effect of the target auxiliary area generated by an auxiliary virtual object for a target virtual object.

As an exemplary implementation, the operation of displaying, within the target auxiliary area, the target virtual object in the protected state in a target display mode includes one of the following:

1) Hide the target virtual object in an object field of view of the enemy virtual object.

2) Blur the target virtual object in the object field of view of the enemy virtual object.

3) Spoof the target virtual object in the object field of view of the enemy virtual object, including: determining a spoofing image according to a scene object in a virtual scene where the target virtual object is located; and displaying the target virtual object according to the spoofing image.

In this implementation, three exemplary display mode adjustment methods are provided. In the first mode, the display adjustment mode of the target virtual object may be hiding the target virtual object, so that the enemy virtual object cannot find a position of the target virtual object, and consequently, an attack cannot be launched for the target virtual object, thereby protecting the target virtual object.

In the foregoing second mode, as shown in FIG. 5, the display adjustment mode of the target virtual object may be blurring the target virtual object, so that the enemy virtual object cannot find an accurate position of the target virtual object, and consequently, the target virtual object cannot be accurately aimed, thereby protecting the target virtual object.

In the foregoing third mode, the display adjustment mode of the target virtual object may be spoofing the target virtual object. To be specific, an image of an environment near the target virtual object is obtained, and the target virtual object is displayed, to implement spoofing of the target virtual object, so that the enemy virtual object cannot find an accurate position of the target virtual object, and consequently, the target virtual object cannot be accurately aimed, thereby protecting the target virtual object.

As an exemplary implementation, after the target virtual object located in the target auxiliary area is set to a protected state, the method further includes the following operations.

S1: Display, in response to an attack operation launched on an enemy virtual object, the enemy virtual object having an activity state parameter lower than a target threshold in a current virtual scene.

S2: Display a second auxiliary virtual object (or an enemy auxiliary virtual object) that is associated with the enemy virtual object to move to a position of the enemy virtual object.

S3: Display, in response to a target auxiliary operation performed by the enemy auxiliary virtual object, the enemy virtual object in the current virtual scene according to a second display mode.

In this implementation, the auxiliary area and the corresponding second display mode are described through an object perspective of the target virtual object.

In this implementation, the enemy virtual object is first displayed in the object field of view of the target virtual object in the first display mode. Specifically, in this implementation, the first display mode may be an original display mode of the enemy virtual object. Next, in response to the attack operation performed by the target virtual object on the enemy virtual object, when the enemy virtual object is in a state in which the activity state parameter is less than the target threshold, the enemy auxiliary virtual object corresponding to the enemy virtual object may be displayed in the object field of view of the target virtual object to move to the proximity of the enemy virtual object, and the enemy virtual object is displayed in the second display mode through the target auxiliary operation performed by the enemy auxiliary virtual object.

The target auxiliary operation performed by the enemy auxiliary virtual object is an auxiliary operation for generating an auxiliary area for the enemy virtual object. In an exemplary mode, the auxiliary area generated for the enemy virtual object is visible for the target virtual object. In another mode, the auxiliary area generated for the enemy virtual object is invisible to the target virtual object.

Further, after the enemy auxiliary virtual object generates, through the target auxiliary operation, the auxiliary area for the enemy virtual object, the display mode of the enemy virtual object may be adjusted to protect the enemy virtual object.

According to the foregoing implementation of the present disclosure, an enemy virtual object is displayed in a current virtual scene in a first display mode. In a case that an activity state parameter of the enemy virtual object is lower than a target threshold, an enemy auxiliary virtual object associated with the enemy virtual object is displayed to move to a position of the enemy virtual object. In response to a target auxiliary operation performed by the enemy auxiliary virtual object, the enemy auxiliary virtual object is displayed in the current virtual scene according to a second display mode, so that the display mode of the virtual object may be adjusted through an auxiliary skill of the auxiliary virtual object, thereby providing protection for a virtual object in an auxiliary area.

As an exemplary implementation, the operation of displaying the enemy virtual object in the current virtual scene according to the second display mode includes one of the following:

1) Hide the enemy virtual object in the current virtual scene.

2) Blur the enemy virtual object in the current virtual scene.

3) Spoof the enemy virtual object in the current virtual scene, including: determining a spoofing image according to a scene object in a virtual scene where the enemy virtual object is located; and displaying the target virtual object according to the spoofing image.

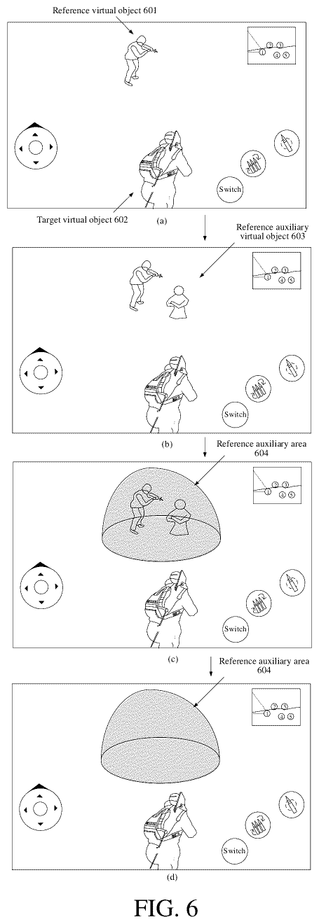

The following describes an exemplary implementation of the foregoing mode for protecting the first auxiliary virtual object with reference to FIG. 6.

As shown in (a) of FIG. 6, a reference virtual object in an enemy camp, i.e. an enemy virtual object 601, and a target virtual object 602 are displayed in a current virtual scene of a target virtual object. In the current scene, the target virtual object 602 may launch an attack to the enemy virtual object 601, so that a virtual life value of the enemy virtual object 601 is reduced to be less than a target threshold.

Next, as shown in (b) of FIG. 6, in response to that the virtual life value of the enemy virtual object 601 is reduced to be less than the target threshold, a second auxiliary virtual object (or a reference auxiliary virtual object) 603 moving to the side of the enemy virtual object 601 is displayed in the current scene, and an auxiliary operation performed by the second auxiliary virtual object 603 is displayed.

As shown in (c) of FIG. 6, in a case that the second auxiliary virtual object 603 is a second auxiliary area (or a reference auxiliary area) 604 generated by the enemy virtual object 601 is visible to the target virtual object 602, it is displayed that the second auxiliary virtual object 603 and the enemy virtual object 601 are located in the semi-transparent second auxiliary area 604. Finally, as shown in (d) of FIG. 6, the second auxiliary virtual object 603 and the enemy virtual object 601 in the second auxiliary area 604 are hidden.

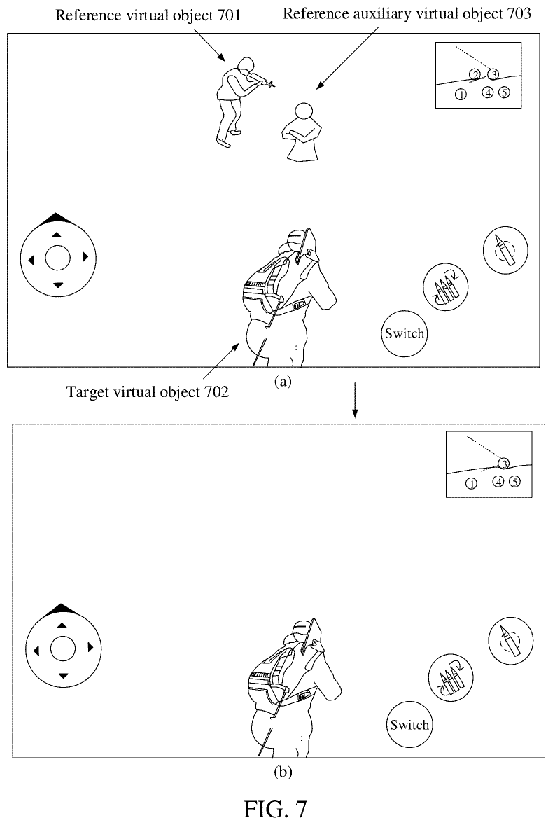

Another exemplary implementation of the foregoing implementation is described below with reference to FIG. 7.

As shown in (a) of FIG. 7, in a case that a target virtual object 702 launches an attack to an enemy virtual object 701 of an enemy camp, so that a virtual life value of the enemy virtual object 701 is reduced to be less than a target threshold, a second auxiliary virtual object 703 moving to the side of the enemy virtual object 701 is displayed in a current scene, and an auxiliary operation performed by the second auxiliary virtual object 703 is displayed.

If the second auxiliary virtual object 703 is a second auxiliary area generated by the enemy virtual object 701 is invisible to the target virtual object 702, the second auxiliary virtual object, the enemy virtual object, and the generated second auxiliary area may be hidden as shown in (b) of FIG. 7.

In the foregoing two implementations shown in FIG. 6 and FIG. 7, a virtual object in an auxiliary area may be hidden, so as to prevent a virtual object or an auxiliary virtual object in an adversarial camp from finding a virtual object with a relatively low virtual life value. Consequently, an attack cannot be launched for the virtual object, or even if the attack is performed, the virtual object cannot be hit, thereby protecting the virtual object.

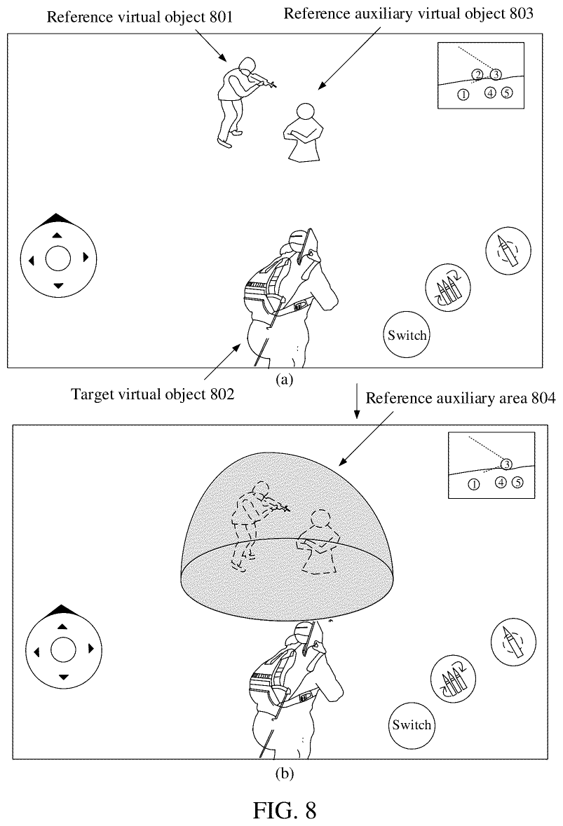

Still another exemplary implementation of the foregoing implementation is described below with reference to FIG. 8.

As shown in (a) of FIG. 8, in a case that a target virtual object 802 launches an attack to an enemy virtual object 801, so that a virtual life value of the enemy virtual object 801 is reduced to be less than a target threshold, a second auxiliary virtual object 803 moving to the side of the enemy virtual object 801 is displayed in a current scene, and an auxiliary operation performed by the second auxiliary virtual object 803 is displayed.

As shown in (b) of FIG. 8, in a case that a second auxiliary area 804 generated by the second auxiliary virtual object 803 for the enemy virtual object 801 is visible to the target virtual object 802, the second auxiliary virtual object 803 and the enemy virtual object 801 located in the second auxiliary area 804 are blurred.

The foregoing implementation is merely an exemplary description. A specific display mode of the virtual object in the auxiliary area is not limited.

According to the foregoing implementation of the present disclosure, a virtual object located in an auxiliary area is displayed in a mode, so as to avoid that the virtual object located in the auxiliary area is found or attacked by an enemy virtual object or an auxiliary virtual object of an enemy virtual object, thereby achieving an effect of protecting the virtual object located in the auxiliary area.

As an exemplary implementation, the operation of displaying, in response to a target auxiliary operation performed by the enemy auxiliary virtual object, the enemy virtual object in the current virtual scene according to a second display mode further includes: canceling displaying, in a virtual thumbnail map corresponding to the current virtual scene, a reference object identifier corresponding to the enemy virtual object, where the virtual thumbnail map is configured for thumbnail display of a virtual game scene.

In this implementation, when the enemy virtual object is displayed in the second display mode, an object identifier corresponding to the enemy virtual object may be hidden on the virtual thumbnail map, to avoid that the target virtual object finds the enemy virtual object located in the auxiliary area.

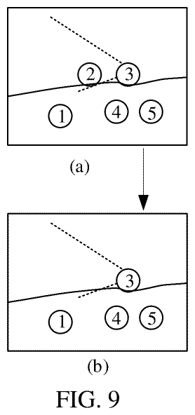

The foregoing implementation is described below with reference to FIG. 7 and FIG. 9.

As shown in (a) of FIG. 7 and (a) of FIG. 9, a plurality of object identifiers are displayed in a thumbnail corresponding to a current game battle, to indicate a plurality of virtual objects in a virtual scene. It is assumed that identifier “3” corresponds to the target virtual object 702 and identifier “2” corresponds to the enemy virtual object 701. Before the enemy virtual object 701 is displayed in the second display mode, identifier “2” is normally displayed in (a) of FIG. 9. Next, as shown in (b) of FIG. 7 and (b) of FIG. 9, in a case that the enemy virtual object 701 is hidden in (b) of FIG. 7, identifier “2” in (b) of FIG. 9 is synchronously hidden.

According to the foregoing implementation of the present disclosure, in a virtual thumbnail map corresponding to a current virtual scene, display of an enemy object identifier corresponding to an enemy virtual object is canceled. The virtual thumbnail map is configured for thumbnail display of a virtual game scene, so that a target virtual object is prevented from finding the enemy virtual object located in an auxiliary area by means of synchronous hidden display of a minimap, thereby achieving a protection effect for a virtual object located in the auxiliary area.

As an exemplary implementation, after the enemy virtual object is displayed in the current virtual scene according to a second display mode in response to a target auxiliary operation performed by the enemy auxiliary virtual object, the method further includes: displaying, in a case that the target virtual object moves into a second auxiliary area corresponding to the second virtual object, the second virtual object in the second auxiliary area in the first display mode.

In this implementation, when the target virtual object is controlled to move into the second auxiliary area corresponding to the enemy virtual object, display of the enemy virtual object may be restored in the object field of view of the target virtual object.

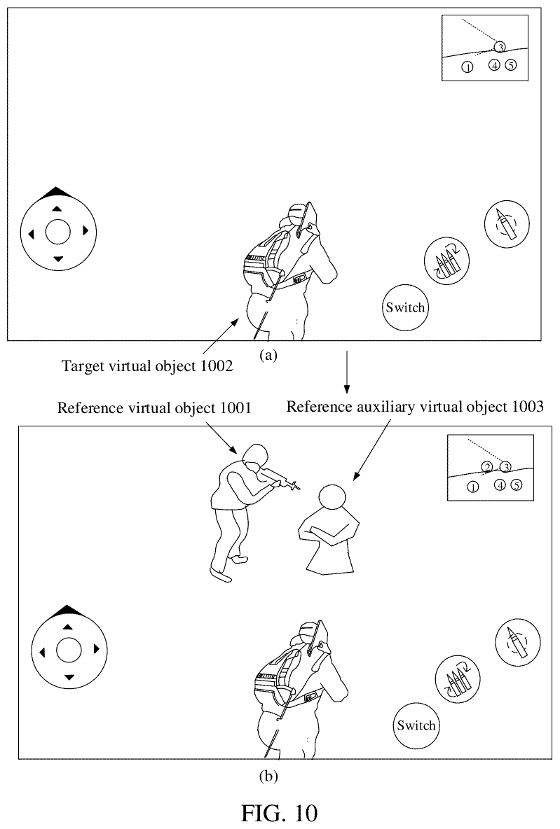

As shown in (a) of FIG. 10, it is assumed that there is only a target virtual object 1002 currently controlled by a player (actually, an enemy virtual object has been hidden in an auxiliary area corresponding to the enemy virtual object) in a current virtual scene. Next, for example, as shown in (b) of FIG. 10, in a case that the target virtual object 1002 is controlled to move forward, assuming that the current target virtual object 1002 enters an auxiliary area corresponding to an enemy virtual object 1001, the enemy virtual object 1001 and a second auxiliary virtual object 1003 may be restored to be displayed in the current virtual scene.

According to the foregoing implementation of the present disclosure, by displaying an enemy virtual object in a second auxiliary area in a first display mode in a case that a target virtual object moves into the second auxiliary area corresponding to the enemy virtual object, a current virtual object may be controlled to enter an auxiliary area in a case that the enemy virtual object is hidden in the auxiliary area, so as to re-find a hidden enemy virtual object, and start a battle again, thereby preventing an enemy virtual object in an adversarial camp from always hiding to adopt a battle avoidance policy and slowing down a game process.

As an exemplary implementation, the operation of controlling, in response to the activity state parameter of the target virtual object being lower than a target threshold, the auxiliary virtual object to generate a target auxiliary area for the target virtual object includes the following operations.

S1: Display a target auxiliary action performed by the first auxiliary virtual object in the current virtual scene when the first auxiliary virtual object moves into the current virtual scene, where the target auxiliary action is configured for indicating a display range of the target auxiliary area.

S2: Display the target auxiliary area in a preset display mode within the display range.

In this implementation, after the auxiliary virtual object needs to perform an auxiliary action, the target auxiliary area is determined in the current virtual scene according to the auxiliary action of the auxiliary virtual object.

In this implementation, the target auxiliary area generated for the target virtual object may further be configured with a display mode. The foregoing display mode may include, but is not limited to, a display mode such as an area shape of the target auxiliary area or an area display image.

In an exemplary implementation, the generated target auxiliary area may be indicated by displaying a semi-transparent shadow in the virtual space, or the target auxiliary area may be displayed by displaying a semi-transparent virtual halo in the virtual space. In this implementation, the display mode of the target auxiliary area is not limited.

According to the foregoing implementation of the present disclosure, in a case that the auxiliary virtual object is moved into the current virtual scene, the auxiliary virtual object is displayed to perform the target auxiliary action in the current virtual scene. The target auxiliary area is displayed in the display range in the target display mode, so that the target auxiliary area is determined through an auxiliary action and a display mode, and the target virtual object is prompted to enter the auxiliary area so as to enter the protected state.

As an exemplary implementation, the operation of controlling, in response to the activity state parameter of the target virtual object being lower than a target threshold, the auxiliary virtual object to generate a target auxiliary area for the target virtual object further includes performing at least one of the following:

1) Determine, when a living state parameter of the target virtual object is less than a living parameter threshold, the first auxiliary virtual object located within a target range associated with the target virtual object, where the activity state parameter includes the living state parameter.

2) Determine, when a moving state parameter of the target virtual object is lower than a moving parameter threshold, the first auxiliary virtual object located within a target range associated with the target virtual object, where the moving state parameter is configured for indicating a virtual moving speed of the target virtual object, and the activity state parameter includes the moving state parameter.

3) Determine, when an attack state parameter of the target virtual object is less than an attack parameter threshold, the first auxiliary virtual object located within a target range associated with the target virtual object, where the activity state parameter includes the attack state parameter.

4) Determine, when an armor state parameter of the target virtual object is less than an armor parameter threshold, the first auxiliary virtual object located within a target range associated with the target virtual object, where the activity state parameter includes the armor state parameter.

In this implementation, corresponding to different types of activity state parameters, in a case that the activity state parameters of the target virtual object are less than the target threshold, virtual activity states of the target virtual object are different. For example, in a case that the activity state parameter is a virtual life value, the activity state parameter of the target virtual object being less than the target threshold may be configured for indicating that the target virtual object is in a state in which the virtual life value is relatively low and the target virtual object is to be eliminated from the game. For another example, in a case that the activity state parameter is a virtual attack force, the activity state parameter of the target virtual object being less than the target threshold may be configured for indicating that the target virtual object is in an impact of a debuff that reduces the virtual attack force. For another example, in a case that the activity state parameter is a virtual moving speed, the activity state parameter of the target virtual object being less than the target threshold may be configured for indicating that the target virtual object is in an impact of a debuff of reducing the moving speed. For another example, in a case that the activity state parameter is a virtual armor, the activity state parameter of the target virtual object being less than the target threshold may be configured for indicating that the target virtual object is in an impact of a debuff of reducing the virtual armor. In this implementation, a specific state meaning corresponding to that the activity state parameter of the target virtual object is less than the target threshold is not limited.

Further, in a case that the activity state parameter of the target virtual object is less than the target threshold, it may be determined that the current target virtual object is in a state in which the virtual life value is less than the target threshold or is in an impact of a debuff caused by the virtual object in the adversarial camp, and then it is determined that the current target virtual object is in a state in which the current target virtual object needs to assist the virtual object in providing a protection skill.

As an exemplary implementation, the operation of displaying an auxiliary virtual object to perform a target auxiliary action in a current virtual scene includes one of the following:

1) Determine, when the first auxiliary virtual object moves to the target position of the target virtual object, the display range of the target auxiliary area according to the target position, where the display range includes the target position, and the target auxiliary action includes a moving action performed by the first auxiliary virtual object according to the target position.

2) Display, in the current virtual scene, the first auxiliary virtual object to move according to a target trajectory, and determine the display range of the target auxiliary area according to the target trajectory, where the display range of the target auxiliary area is an area range corresponding to the target trajectory, and the target auxiliary action includes a moving action performed by the first auxiliary virtual object according to the target trajectory.

This implementation provides two exemplary target auxiliary actions. In the first mode, the target auxiliary action may be that the first auxiliary virtual object directly moves to a position of the target virtual object, and then determines the target auxiliary area according to the position of the target virtual object. In this implementation, the target auxiliary area may be determined according to the position of the target virtual object, and an area shape and size of the target auxiliary area and a display mode may be pre-configured. For example, the target auxiliary area may be a semi-spherical space area (as shown in (b) of FIG. 8). For another example, the target auxiliary area may alternatively be a cylindrical space area. A specific form of the foregoing target auxiliary area is not limited in this implementation.

In the second mode, the target auxiliary action may be a moving operation of moving, by the first auxiliary virtual object, along a target trajectory. The target trajectory may be a preset circular trajectory, an elliptical trajectory, a square trajectory, or the like, or may be a temporary trajectory that is determined in response to a sliding operation triggered by a current player on a current interface in a case that the auxiliary action of the first auxiliary virtual object is triggered. In this implementation, a specific form and determining method of the target trajectory are not limited.

An area display range of the target auxiliary area may be determined according to the target trajectory. For example, in a case that the target trajectory is determined as a circular trajectory, the target auxiliary area may be a cylindrical space with the circular trajectory as a bottom.

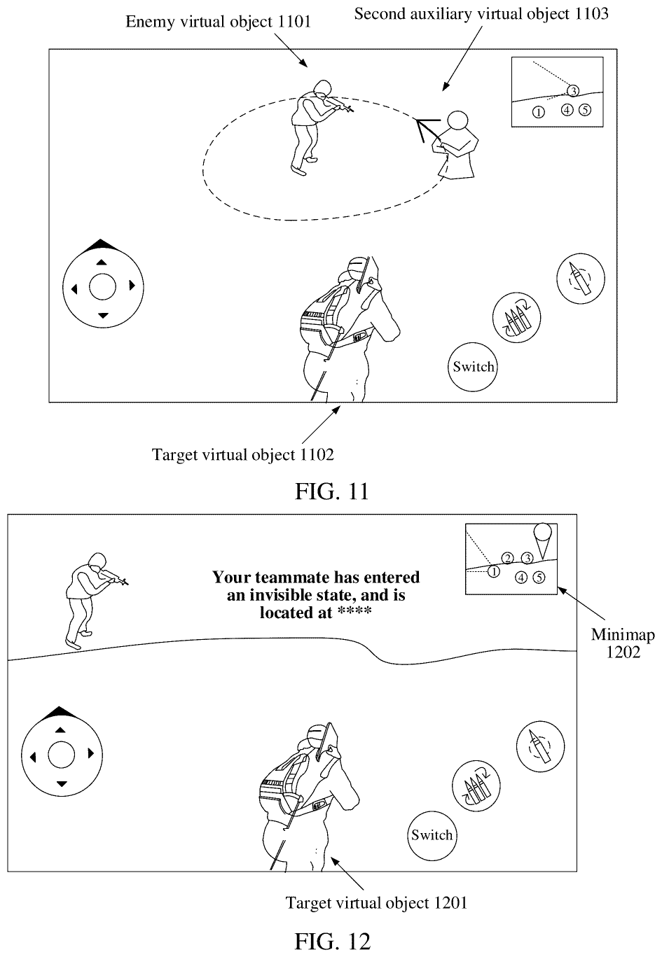

The foregoing implementation is described below with reference to FIG. 11. As shown in FIG. 11, in a third-person perspective of a target virtual object 1102, an enemy virtual object 1101 and a corresponding second auxiliary virtual object 1103 are displayed. Currently, the second auxiliary virtual object 1103 is moving along a circular trajectory on the ground, to generate an auxiliary area for the enemy virtual object 1101.

In the foregoing implementation, the second auxiliary virtual object needs to complete virtual skill casting through a moving operation. To avoid that the enemy virtual object disappears from the field of view, a current player may control the target virtual object to launch an attack against the second auxiliary virtual object, to interrupt continuous skill casting of the second auxiliary virtual object, thereby avoiding that the enemy virtual object enters the auxiliary area to be hidden.

In a case that the target trajectory is a temporary trajectory determined by a sliding operation triggered by a player on a current interface, the player may determine, through a drawing operation in a current virtual scene, an auxiliary area of a suitable size to protect a virtual object controlled by a friend player. In a case that the range of a drawn trajectory is larger, the auxiliary area generated through the auxiliary virtual object is larger, and more virtual objects controlled by a friend player may be protected. However, since the trajectory is longer, the auxiliary virtual object is attacked by a virtual object controlled by an enemy player to be forced to interrupt skill casting. In a case that the range of the drawn trajectory is smaller, the auxiliary area generated through the auxiliary virtual object is smaller, so that a small quantity of virtual objects controlled by a friend player may be protected. However, since the trajectory is relatively short, the auxiliary virtual object may rapidly complete skill casting, is less likely to be attacked by a virtual object controlled by an enemy player, and is successfully hidden in the generated auxiliary area.

According to the foregoing implementation of the present disclosure, two exemplary implementations provide two methods for determining the auxiliary area, and setting of continuous skill cast of the auxiliary virtual object is used, so that the game richness is improved, and the policy of the game is improved.

As an exemplary implementation, after the auxiliary virtual object is controlled to generate a target auxiliary area for the target virtual object in response to the activity state parameter of the target virtual object being lower than a target threshold, the method further includes the following operations.

S1: Determine, according to a parameter type of the activity state parameter, that the target virtual object enters a rescue demand state.

S2: Transmit rescue prompt information to a first virtual object (i.e., a friend virtual object), where the rescue prompt information is configured for indicating a current rescue demand state of the target virtual object, and the first virtual object and the target virtual object are located in a same camp.

S3: Cancel the rescue demand state of the target virtual object in response to a rescue operation of the friend virtual object located in the target auxiliary area.

In this implementation, in a case that the activity state parameter of the target virtual object is lower than the target threshold, the rescue prompt information may be transmitted to the friend virtual object, so that the target virtual object is restored to a normal state through the rescue operation of the friend virtual object.

As an exemplary implementation, the operation of transmitting rescue prompt information to a friend virtual object includes the following operations.

S1: Generate the rescue prompt information according to position information of the target auxiliary area, where the rescue prompt information includes a position of the target auxiliary area in a virtual scene.

S2: Transmit the rescue prompt information to the friend virtual object.

In this implementation, after the target auxiliary area is generated for the target virtual object through the auxiliary virtual object, prompt information may be transmitted to virtual objects in a same camp, to instruct the virtual objects in the same camp to head for a current auxiliary area to seek protection, or prompt the virtual objects in the same camp to head for the auxiliary area to provide restoration of a virtual life value for the target virtual object.

The foregoing implementation is described below with reference to FIG. 12. FIG. 12 shows a target virtual object 1201 in a current virtual scene and a minimap 1202 at an upper right corner. In a case that a virtual life value of a friend virtual object in a same game camp as the target virtual object is less than a target threshold, and an auxiliary area is generated through a corresponding auxiliary virtual object, when auxiliary area prompt information transmitted by the friend virtual object may be received, prompt information “Your teammate has entered an invisible state, and is located at . . . ”, and a position mark is displayed on the minimap 1202, to direct the target virtual object to head to an auxiliary area in which the friend virtual object is located.

According to the foregoing implementation of the present disclosure, auxiliary area prompt information is generated according to position information of a target auxiliary area, where the auxiliary area prompt information is configured for indicating a position of the target auxiliary area in a virtual scene. The auxiliary area prompt information is transmitted to a virtual object in a teammate camp, thereby achieving a technical effect of prompting virtual objects in a same camp to head for a current position to jointly seek protection of an auxiliary area.

As an exemplary implementation, after the auxiliary area prompt information is transmitted to the virtual object in the teammate camp, the method further includes the following operations.

S1: Display reference protection prompt information in response to the friend virtual object entering the target auxiliary area, where the reference protection prompt information is configured for indicating that the friend virtual object is in a protected state relative to the enemy virtual object.

S2: Increase, when the friend virtual object performs a virtual treatment operation on the target virtual object, a value of a living state parameter of the target virtual object according to the virtual treatment operation, where the virtual treatment operation is configured for increasing the living state parameter, and the living state parameter is configured for indicating an adversarial activity state of the target virtual object.

In this implementation, in a case that the virtual object in the teammate camp enters the target auxiliary area, the same protection effect may be provided to the friend virtual object through the target auxiliary area. For example, in the foregoing case that the protected state indicates an invisible state, the same invisible effect is provided for the virtual object in the teammate camp. In this implementation, the virtual object in the teammate camp may further provide a restoration operation of a living state parameter for the target virtual object through a virtual treatment operation, so that in a case that the virtual object in the teammate camp is not found by a virtual object in an adversarial camp, restoration of the virtual life value is provided for the target virtual object through the virtual object in the teammate camp.

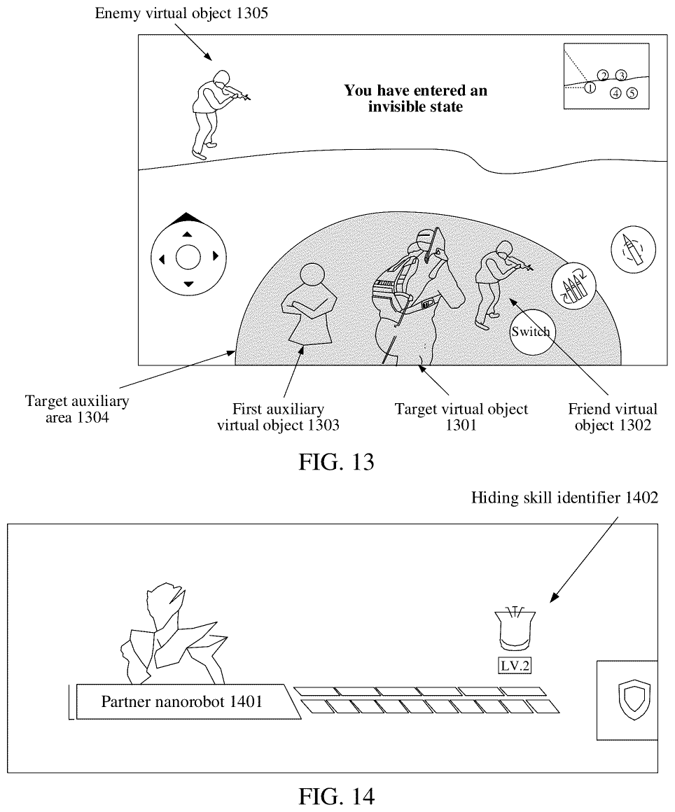

The foregoing implementation is described below with reference to FIG. 13. As shown in FIG. 13, when a friend virtual object 1302 enters a target auxiliary area 1304 generated by a first auxiliary virtual object 1303 for a target virtual object 1301, the target virtual object 1301, the friend virtual object 1302, and the first auxiliary virtual object 1303 in the target auxiliary area 1304 are displayed in a first display mode, indicating that the target virtual object 1301, the friend virtual object 1302, and the first auxiliary virtual object 1303 are in a hidden state in an object field of view of an enemy virtual object 1305, and are not found by the enemy virtual object 1305.

According to the foregoing implementation of the present disclosure, reference protection prompt information is displayed in response to a first virtual object in a teammate camp entering a target auxiliary area. In a case that the first virtual object performs a virtual treatment operation on a target virtual object, a value of a living state parameter of the target virtual object is increased according to the virtual treatment operation, to implement synchronization protection on a friend virtual object, and a treatment and rescue operation on the target virtual object is also implemented through the friend virtual object.

As an exemplary implementation, after the first auxiliary virtual object is controlled to generate a target auxiliary area for the target virtual object, the method further includes one of the following:

1) Prompt, in response to a moving operation of the target virtual object, the target virtual object to be released from the protected state when a current position of the target virtual object is not in the target auxiliary area.

2) Obtain the current position of the target virtual object in response to the moving operation of the target virtual object, and update an area position corresponding to the target auxiliary area in real time according to the current position.

In this implementation, two exemplary interaction modes are provided according to a moving operation of the target virtual object. In the first interaction mode, in a case that the target virtual object moves out of the target auxiliary area, the target virtual object is controlled to be released from the protected state. For example, in a case that the protected state is an invisible state, the target virtual object may exit the invisible state when leaving the target auxiliary area.

In another exemplary mode, the target auxiliary area generated by the first auxiliary virtual object for the target virtual object may be a virtual area bound to a position of the target virtual object. To be specific, in a case that the target virtual object moves, the target auxiliary area is controlled to move with the target virtual object, so that in a case that the target virtual object in the auxiliary area is attacked by an enemy virtual object, the target virtual object may move in an invisible or special display mode, thereby achieving a protection effect with higher strength.

According to the foregoing implementation of the present disclosure, two exemplary modes of determining a target auxiliary area are configured for providing two different protection methods, thereby improving richness of adversarial policies in a game process.

As an exemplary implementation, after the auxiliary virtual object is controlled to generate a target auxiliary area for the target virtual object, the method further includes the following operations.

S1: Obtain an area effective duration configured for the target auxiliary area.

S2-1: Cancel displaying the target auxiliary area when a display duration of the target auxiliary area is greater than or equal to the area effective duration.

S2-2: Keep displaying the target auxiliary area when the display duration of the target auxiliary area is less than the area effective duration.

In this implementation, a duration may be configured for the target auxiliary area. In a case that the duration ends, the target auxiliary area is canceled from the virtual scene. The target auxiliary area is kept in the virtual scene in a case that the duration does not end. In a case that the target auxiliary area is canceled in the virtual scene, the target virtual object that is originally in the invisible state in the target auxiliary area restores to a normal display state.

According to the foregoing implementation of the present disclosure, a duration of the target auxiliary area may be configured, so as to control the target virtual object to be protected within a particular time, thereby preventing the target virtual object from continuously hiding and not participating in confrontation, and affecting experience of a game player. Setting of the duration enables the virtual object to actively participate in game confrontation, thereby improving game confrontation and interaction.

The following describes an exemplary implementation. In an exemplary game pattern, a 3+1 Player VS Environment (PvE) level process is used. Specifically, the game pattern includes three common levels and a final level. A player first passes through the three common levels through a three-player team, the duration of the first three levels is fixed, the game ends if all the players are eliminated, and the final level is entered after the first three levels are passed.

In the first three levels, a player controls a virtual object to obtain a virtual resource in a virtual environment, randomly obtains an auxiliary skill that may be matched for a partner nanorobot within a period of time in the battle, and constructs a defense according to the obtained virtual resource. The auxiliary skill may include, but is not limited to, an auxiliary skill that improves a moving speed of the partner nanorobot, and an auxiliary skill for improving to assist in the attack force of the nanorobot is improved.

In this implementation, in each round of levels of each player, a player may purchase an auxiliary skill (a virtual microchip) through a virtual store in a game, and there is a probability of a counting-type skill (i.e., an auxiliary skill with a limited number of use times) appearing in the store.

In the game process, the player may attack a virtual object (NPC object) controlled by a computer in a virtual scene through a controlled target virtual object. In a case that the NPC object is defeated, the defeated NPC object may be “acclimated” to a first auxiliary virtual object subordinate to the target virtual object, and the first auxiliary virtual object may be configured with an auxiliary skill corresponding to the virtual microchip. For example, when a skill corresponding to the virtual microchip obtained by the player is “Create a protection area” and when the player controls the target virtual object to defeat the NPC virtual object, the defeated NPC virtual object may be converted into the first auxiliary virtual object subordinate to the target virtual object, and the first auxiliary virtual object is configured with the auxiliary skill “Create a protection area” corresponding to the virtual microchip. Further, in a case that a skill cast condition is satisfied, the first auxiliary virtual object may automatically cast the skill of “Create a protection area” for the target virtual object.

As shown in FIG. 14, a partner nanorobot 1401, as a first auxiliary virtual object, may obtain a capability. An icon of a corresponding capability, such as a hiding skill identifier 1402, may appear on an area corresponding to an object identifier of the partner nanorobot 1401 of the player, to indicate that the partner nanorobot may provide a hiding protection effect for a virtual object controlled by the player.

When a player configured with the partner nanorobot 1401 is fatally injured and enters a fall-down state, the partner nanorobot 1401 automatically releases a hidden force field (i.e., the target auxiliary area) to a position of the player, and a friend object entering the hidden force field is endowed with an invisible effect. At this moment, all friend objects entering the hidden force field enter an invisible state. In the invisible state, a player in the hidden force field is not sensed by an enemy player and an enemy nanorobot. In addition, the enemy nanorobot may not actively attack the player in the hidden force field. Even if the fall-down player is backed up, the player does not leave the invisible state. Only when the duration of the hidden force field ends or the player actively leaves the force field, the player leaves the invisible state.

In this implementation, the first auxiliary virtual object is configured with two different virtual forms, including an arm form and an independent form, and a player may actively switch the virtual form of the first auxiliary virtual object. When the first auxiliary virtual object is configured with an arm form, a gain effect or a skill (for example, the foregoing hidden force field casting skill) may be provided to the target virtual object. When the first auxiliary virtual object is configured with an independent form, the first auxiliary virtual object may automatically attack another enemy virtual object according to a skill configured by the first auxiliary virtual object and according to certain attack logic, or a player may specify a target, to control the first auxiliary virtual object to launch an attack to the specified target.

In this implementation, the hidden force field is also one of skills of the first auxiliary virtual object. When the first auxiliary virtual object is in the arm form, the hidden force field may be cast for the target virtual object, to protect the target virtual object. In this process, if the player actively switches the virtual state of the first auxiliary virtual object from the arm form to the independent form, the hidden force field disappears.

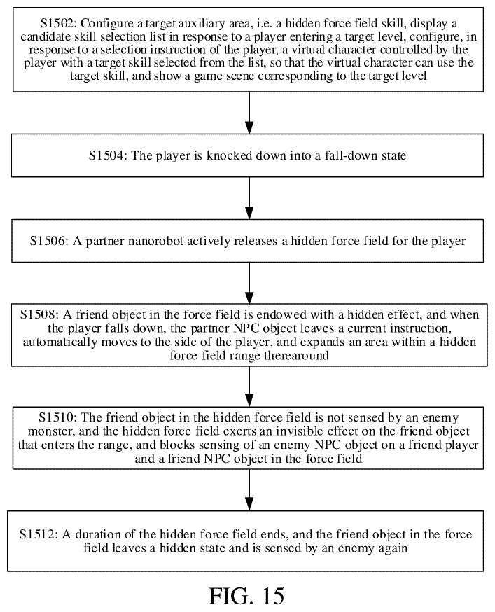

A complete process of the foregoing implementation is described below with reference to FIG. 15. As shown in FIG. 15:

In operation S1502, a target auxiliary area, i.e. a hidden force field skill, is configured. In response to a player entering a target level, a candidate skill selection list is displayed. In response to a selection instruction of the player, a virtual character controlled by the player is configured with a target skill selected from the list, so that the virtual character can use the target skill. A game scene corresponding to the target level is shown, where the game scene includes a player and an enemy NPC object, and the player and the enemy NPC object are in an enemy relationship.

S1504: The player is knocked down into a fall-down state. When a blood volume of the player decreases to 0, the player enters the fall-down state.

S1506: A partner NPC object actively releases a hidden force field for the player.

S1508: A friend object in the force field is endowed with a hidden effect. When the player falls down, the partner NPC object leaves a current instruction, automatically moves to the side of the player, and expands an area within a hidden force field range therearound.

S1510: The friend object in the hidden force field is not sensed by an enemy monster. The hidden force field exerts an invisible effect on the friend object that enters the range, and blocks sensing of an enemy NPC object on a friend player and a friend NPC object in the force field.

S1512: A duration of the hidden force field ends, and the friend object in the force field leaves a hidden state and is sensed by an enemy again. If the player and the friend object actively leave the range of the force field within the duration of the force field, the player and the friend object may leave the invisible state. If the force field is entered again, the invisible effect may still be endowed.

Finally, after the duration of the hidden force field ends, a force field area is destroyed. At this moment, the friend object within the range leaves the invisible state.

In the foregoing mode, when a player is in a fall-down state, a partner NPC object may expand a hidden force field to protect the player. In addition, if a friend object comes to rescue the player in the fall-down state, the friend object is protected from being disturbed by an enemy monster, thereby improving a success rate of rescue.

In the foregoing implementation, an auxiliary virtual object is configured for a target virtual object, an auxiliary area for providing protection is automatically generated for the target virtual object through the auxiliary virtual object in a case that an activity state parameter of the target virtual object is less than a target threshold, and similar to a case that the target virtual object is located in the auxiliary area, the auxiliary area provides protection for the target virtual object, so as to avoid or resist an attack by a virtual object in an adversarial camp in a case that the target virtual object is frail or has relatively high operating difficulty, thereby prolonging a living time of the target virtual object in a game battle, and solving a technical problem that relatively few protection methods are provided for a virtual object in an existing game process.

To simplify the description, the foregoing method embodiments are described as a series of action combination. However, those of ordinary skill in the art may know that the present disclosure is not limited to any described order of the actions, as some operations may be executed in another order simultaneously according to the present disclosure. In addition, those skilled in the art is also to learn that the embodiments described in this specification are all exemplary embodiments, and the involved actions and modules are not necessarily required to the present disclosure.

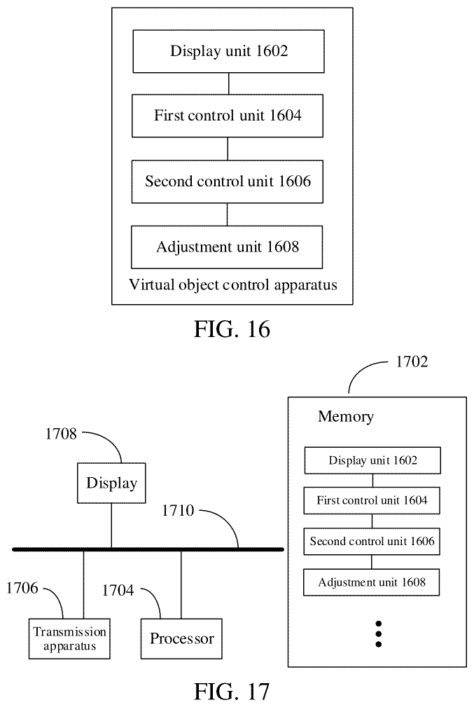

According to another aspect of embodiments of the present disclosure, a virtual object control apparatus for implementing the foregoing virtual object control method is further provided. As shown in FIG. 16, the apparatus includes:
a display unit 1602, configured to display a target virtual object, a second virtual object, and a first auxiliary virtual object associated with the target virtual object in a current virtual scene, where the second virtual object and the target virtual object are located in different camps separately;
a first control unit 1604, configured to reduce an activity state parameter of the target virtual object in response to an attack operation performed by the second virtual object on the target virtual object;
a second control unit 1606, configured to control, in response to the activity state parameter of the target virtual object being lower than a target threshold, the first auxiliary virtual object to generate a target auxiliary area for the target virtual object; and
an adjustment unit 1608, configured to set the target virtual object located in the target auxiliary area to a protected state, where a first hit ratio of the attack operation launched by the second virtual object on the target virtual object in the protected state is lower than a second hit ratio of the attack operation launched by the second virtual object on the target virtual object not in the protected state.

In this embodiment, for embodiments to be implemented by the foregoing unit modules, refer to the foregoing method embodiments. Details are not described herein again.

According to still another aspect of embodiments of the present disclosure, an electronic device for implementing the foregoing virtual object control method is further provided. The electronic device may be a terminal device or a server as shown in FIG. 17. In this embodiment, an example in which the electronic device is the terminal device is used for description. As shown in FIG. 17, the electronic device includes a memory 1702 and a processor 1704. The memory 1702 has a computer program stored therein. The processor 1704 is configured to perform operations in any of the foregoing method embodiments through the computer program.

In this embodiment, the electronic device may be located in at least one of a plurality of network devices in a computer network.

In this embodiment, the processor may be configured to execute the computer program to perform the following operations.

S1: Display a target virtual object, a second virtual object, and a first auxiliary virtual object associated with the target virtual object in a current virtual scene, where the second virtual object and the target virtual object are located in different camps separately.

S2: Reduce an activity state parameter of the target virtual object in response to an attack operation performed by the second virtual object on the target virtual object.

S3: Control, in response to the activity state parameter of the target virtual object being lower than a target threshold, the first auxiliary virtual object to generate a target auxiliary area for the target virtual object. and

S4: Set the target virtual object located in the target auxiliary area to a protected state, where a first hit ratio of the attack operation launched by the second virtual object on the target virtual object in the protected state is lower than a second hit ratio of the attack operation launched by the second virtual object on the target virtual object not in the protected state.

In some embodiments, a person of ordinary skill in the art may understand that a structure shown in FIG. 17 is only schematic. The electronic device may alternatively be a terminal device such as a smartphone (such as an Android mobile phone or an iOS mobile phone), a tablet computer, a palmtop computer, a mobile Internet device (MID), or a PAD. FIG. 17 does not constitute a limitation on a structure of the electronic device. For example, the electronic device may further include more or fewer components (for example, a network interface) than those shown in FIG. 17, or has a configuration different from that shown in FIG. 17.

The memory 1702 may be configured to store a software program and a module, such as a program instruction/module corresponding to the virtual object control method and apparatus in this embodiment of the present disclosure. The processor 1704 executes the software program and the module stored in the memory 1702, to perform various function applications and data processing. To be specific, the foregoing virtual object control method is implemented. The memory 1702 may include a high-speed random-access memory and may further include a non-volatile memory, such as one or more magnetic storage apparatuses, a flash memory, or another non-volatile solid-state memory. In some examples, the memory 1702 may further include memories remotely disposed relative to the processor 1704. The remote memories may be connected to a terminal via a network. Examples of the network include, but are not limited to, the Internet, an Intranet, a local area network, a mobile communication network, and a combination thereof. The memory 1702 may be, but is not limited to, configured to store information such as control information of various elements and virtual objects in a scene picture. As an example, as shown in FIG. 17, the memory 1702 may include, but is not limited to, the display unit 1602, the first control unit 1604, the second control unit 1606, and the adjustment unit 1608 in the foregoing virtual object control apparatus. Furthermore, the memory may further include, but is not limited to, another module unit in the virtual object control apparatus. Details are not described again in this example.

In some embodiments, a transmission apparatus 1706 is configured to receive or transmit data via a network. Examples of the network include a wired network and a wireless network. In an example, the transmission device 1706 includes a network interface controller (NIC). The NIC may be connected to another network device and a router by using a network cable, so as to communicate with the Internet or a local area network. In an example, the transmission device 1706 is a radio frequency (RF) module, which communicates with the Internet in a wireless mode.

Furthermore, the electronic device further includes: a display 1708, configured to display a virtual scene in a display interface; and a connection bus 1710, configured to connect the module components in the electronic device.

In other embodiments, the foregoing terminal device or server may be a node in a distributed system. The distributed system may be a blockchain system. The blockchain system may be a distributed system formed by connecting a plurality of nodes through network communication. A peer to peer (P2P) network may be formed between the nodes. Any form of a computing device, such as the server, the terminal, and another electronic device, may become a node in the blockchain system by joining the peer-to-peer network.

According to an aspect of the present disclosure, a computer program product is provided. The computer program product includes a computer program/instruction. The computer program/instruction includes program code configured for performing the method shown in the flowchart. In such an embodiment, the computer program may be downloaded and installed from a network through the communication part, and/or installed from the removable medium. When executed by a central processing unit, the computer program executes functions provided in this embodiment of the present disclosure.

The sequence numbers of the foregoing embodiments of the present disclosure are merely for description purpose but do not imply the preference among the embodiments.

According to an aspect of the present disclosure, a computer-readable storage medium is provided. A processor of a computer device reads a computer instruction from the computer-readable storage medium. The processor executes the computer instruction, to cause the computer device to perform the foregoing virtual object control method.

In this embodiment, the computer-readable storage medium may be configured to store a computer program configured for performing the following operations.

S1: Display a target virtual object, a second virtual object, and a first auxiliary virtual object associated with the target virtual object in a current virtual scene, where the second virtual object and the target virtual object are located in different camps separately.

S2: Reduce an activity state parameter of the target virtual object in response to an attack operation performed by the second virtual object on the target virtual object.

S3: Control, in response to the activity state parameter of the target virtual object being lower than a target threshold, the first auxiliary virtual object to generate a target auxiliary area for the target virtual object. and

S4: Set the target virtual object located in the target auxiliary area to a protected state, where a first hit ratio of the attack operation launched by the second virtual object on the target virtual object in the protected state is lower than a second hit ratio of the attack operation launched by the second virtual object on the target virtual object not in the protected state.

In this embodiment, those of ordinary skill in the art may understand that all or some operations in the methods of the foregoing embodiments may be performed by a program instructing hardware of the terminal device. The program may be stored in a computer-readable storage medium. The storage medium may include: a flash drive, a Read-Only Memory (ROM), a Random-Access Memory (RAM), a magnetic disk, an optical disc, and the like.

When the integrated unit in the foregoing embodiments is implemented in a form of a software functional unit and sold or used as an independent product, the integrated unit may be stored in the foregoing computer-readable storage medium. Based on such an understanding, the solutions of the present disclosure essentially, or a part contributing to the related art, or all or a part of the technical solution may be implemented in a form of a software product. The computer software product is stored in a storage medium and includes several instructions for instructing one or more computer devices (which may be a personal computer, a server, a network device, or the like) to perform all or some of operations of the methods in the embodiments of the present disclosure.

In the foregoing embodiments of the present disclosure, the descriptions of the embodiments have respective focuses. For a part that is not described in detail in an embodiment, refer to related descriptions in other embodiments.

In the several embodiments provided in the present disclosure, the disclosed client may be implemented in another mode. The foregoing described apparatus embodiments are merely examples. For example, the unit division is merely logical function division and there may be other division modes in other implementations. For example, a plurality of units or components may be combined or integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate parts may or may not be physically separate, and components displayed as units may or may not be physical units. To be specific, the components may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely exemplary implementations of the present disclosure. Those of ordinary skill in the art may further make several improvements and modifications without departing from the principle of the present disclosure, and the improvements and modifications fall within the protection scope of the present disclosure.

What is claimed is:

1. A virtual object control method, performed by an electronic device, comprising:
displaying a target virtual object and an auxiliary virtual object associated with the target virtual object in a current virtual scene;
displaying the auxiliary virtual object performing a target auxiliary action in the current virtual scene;
determining, based on the target auxiliary action, a target auxiliary area; and
setting the target virtual object located in the target auxiliary area to a protected state.

2. The virtual object control method of claim 1, wherein the determining comprises generating, based on an activity state parameter of the target virtual object being lower than a target threshold, the target auxiliary area for the target virtual object.

3. The virtual object control method of claim 2, further comprising:
in response to an attack operation by a second virtual object on the target virtual object, controlling the activity state parameter of the target virtual object to decrease.

4. The virtual object control method according to claim 2, wherein the setting comprises:
displaying, within the target auxiliary area, the target virtual object in the protected state in a target display mode, wherein the target display mode indicates that the target virtual object is displayed in an object field of view of a first virtual object in a first display mode and that the target virtual object is displayed in an object field of view of a second virtual object in a second display mode, and wherein the first virtual object and the target virtual object are in a same camp.

5. The virtual object control method according to claim 1, wherein during the setting, the method further comprises performing at least one of the following:
adjusting a parameter restoration speed of a living state parameter of the target virtual object from a first restoration speed to a second restoration speed, wherein the living state parameter indicates an adversarial activity state of the target virtual object, the parameter restoration speed is the first restoration speed when the target virtual object is located outside the target auxiliary area, and wherein the second restoration speed is greater than the first restoration speed;
increasing the living state parameter of the target virtual object by a first target value;
increasing an attack state parameter of the target virtual object by a second target value, wherein the attack state parameter indicates a damage value at which the target virtual object is allowed to cause a virtual damage to a second virtual object; or
increasing an armor state parameter of the target virtual object by a third target value, wherein the armor state parameter indicates a defense value at which the target virtual object is allowed to defend against a virtual damage caused by the second virtual object.

6. The virtual object control method according to claim 1, wherein the setting comprises:
hiding the target virtual object in an object field of view of a second virtual object;
blurring the target virtual object in the object field of view of the second virtual object; and
spoofing the target virtual object in the object field of view of the second virtual object, wherein the spoofing comprises: determining a spoofing image according to a scene object in a virtual scene where the target virtual object is located; and displaying the target virtual object according to the spoofing image.

7. The virtual object control method according to claim 4, further comprising:
displaying, in response to an attack operation performed on the second virtual object, the second virtual object having an activity state parameter lower than the target threshold in the current virtual scene;
displaying a second auxiliary virtual object that is associated with the second virtual object to move to a position of the second virtual object; and
displaying, in response to a target auxiliary operation performed by the second auxiliary virtual object, the second virtual object in the current virtual scene according to the second display mode.

8. The virtual object control method according to claim 4, further comprising:
canceling displaying, in a virtual thumbnail map corresponding to the current virtual scene, a reference object identifier corresponding to the second virtual object, wherein the virtual thumbnail map is configured for thumbnail display of a virtual game scene.

9. The virtual object control method according to claim 4, further comprising:
displaying, based on the target virtual object moving into a second auxiliary area corresponding to the second virtual object, the second virtual object in the second auxiliary area in the first display mode.

10. The virtual object control method according to claim 1, wherein the displaying the auxiliary virtual object performing the target auxiliary action in the current virtual scene comprises:
displaying, based on the auxiliary virtual object moving into the current virtual scene, the target auxiliary action performed by the auxiliary virtual object in the current virtual scene, wherein the target auxiliary action indicates a display range of the target auxiliary area; and
displaying the target auxiliary area in a preset display mode within the display range.

11. The virtual object control method according to claim 2, further comprising performing at least one of the following:
determining, based on a living state parameter of the target virtual object being less than a living parameter threshold, the auxiliary virtual object located within a target range associated with the target virtual object, wherein the activity state parameter comprises the living state parameter;
determining, based on a moving state parameter of the target virtual object being lower than a moving parameter threshold, the auxiliary virtual object located within a target range associated with the target virtual object, wherein the moving state parameter indicates a virtual moving speed of the target virtual object, and the activity state parameter comprises the moving state parameter;
determining, based on an attack state parameter of the target virtual object being less than an attack parameter threshold, the auxiliary virtual object located within a target range associated with the target virtual object, wherein the activity state parameter comprises the attack state parameter; and
determining, based on an armor state parameter of the target virtual object being less than an armor parameter threshold, the auxiliary virtual object located within a target range associated with the target virtual object, wherein the activity state parameter comprises the armor state parameter.

12. The virtual object control method according to claim 10, wherein the displaying the auxiliary virtual object performing the target auxiliary action in the current virtual scene comprises:
determining, based on the auxiliary virtual object moving to a target position of the target virtual object, the display range of the target auxiliary area according to the target position, wherein the display range comprises the target position, and the target auxiliary action comprises a moving action performed by the auxiliary virtual object according to the target position;
displaying, in the current virtual scene, the auxiliary virtual object to move according to a target trajectory; and
determining the display range of the target auxiliary area according to the target trajectory, wherein the display range is an area range corresponding to the target trajectory, and the target auxiliary action comprises a moving action performed by the auxiliary virtual object according to the target trajectory.

13. The virtual object control method according to claim 2, further comprising:
determining, based on a parameter type of the activity state parameter, that the target virtual object enters a rescue demand state;
transmitting rescue prompt information to a first virtual object, wherein the rescue prompt information indicates a current rescue demand state of the target virtual object, and wherein the first virtual object and the target virtual object are located in a same camp; and
canceling, in response to a rescue operation of the first virtual object located in the target auxiliary area, the current rescue demand state of the target virtual object.

14. The virtual object control method according to claim 13, wherein the transmitting the rescue prompt information to the first virtual object comprises:
generating the rescue prompt information based on position information of the target auxiliary area, wherein the rescue prompt information comprises a position of the target auxiliary area in a virtual scene; and
transmitting the rescue prompt information to the first virtual object.

15. The virtual object control method according to claim 13, wherein after the transmitting the rescue prompt information to the first virtual object, the method further comprises:
displaying, in response to the first virtual object entering the target auxiliary area, reference protection prompt information, wherein the reference protection prompt information indicates that the first virtual object is in the protected state; and
increasing, based on the first virtual object performing a virtual treatment operation on the target virtual object, a value of a living state parameter of the target virtual object according to the virtual treatment operation, wherein the virtual treatment operation is configured to increase the living state parameter, and wherein the living state parameter indicates an adversarial activity state of the target virtual object.

16. The virtual object control method according to claim 1, further comprising at least one of the following:
prompting, in response to a moving operation of the target virtual object and based on a current position of the target virtual object being outside the target auxiliary area, the target virtual object to be released from the protected state; or
obtaining, in response to the moving operation of the target virtual object, the current position of the target virtual object; and updating an area position corresponding to the target auxiliary area in real time according to the current position.

17. The virtual object control method according to claim 15, further comprising:
obtaining an area effective duration configured for the target auxiliary area;
canceling displaying, based on a display duration of the target auxiliary area being greater than or equal to the area effective duration, the target auxiliary area; and
keeping displaying, based on the display duration of the target auxiliary area being less than the area effective duration, the target auxiliary area.

18. A non-transitory computer-readable storage medium, when executed by, cause:
displaying a target virtual object and an auxiliary virtual object associated with the target virtual object in a current virtual scene;
displaying the auxiliary virtual object performing a target auxiliary action in the current virtual scene;
determining, based on the target auxiliary action, a target auxiliary area; and
setting the target virtual object located in the target auxiliary area to a protected state.

19. An electronic device, comprising:
one or more processors; and
memory storing instructions that, when executed by the one or more processors, cause the electronic device to:
display a target virtual object and an auxiliary virtual object associated with the target virtual object in a current virtual scene;
display the auxiliary virtual object performing a target auxiliary action in the current virtual scene;
determine, based on the target auxiliary action, a target auxiliary area; and
set the target virtual object located in the target auxiliary area to a protected state.

20. The electronic device according to claim 19, wherein the instructions, when executed by the one or more processors, cause the electronic device to set the target virtual object located in the target auxiliary area to the protected state by:
hiding the target virtual object in an object field of view of a second virtual object;
blurring the target virtual object in the object field of view of the second virtual object; and
spoofing the target virtual object in the object field of view of the second virtual object, wherein the spoofing comprises: determining a spoofing image according to a scene object in a virtual scene where the target virtual object is located; and displaying the target virtual object according to the spoofing image.
